(19) United States
(12) Patent Application Publication
(10) Pub. No.: US 2020/0079174 A1
(43) Pub. Date: Mar. 12, 2020

(54) AIR-CONDITIONING SYSTEM

(71) Applicant: Mahle International GmbH, Stuttgart (DE)

(72) Inventors: Holger Laux, Dietingen (DE); Erich Litwing, Spraitbach (DE); Philipp Kullen, Muenchen (DE); Vincenzo Venezia, Magstadt (DE)

(21) Appl. No.: 16/562,433

(22) Filed: Sep. 5, 2019

(30) Foreign Application Priority Data
Sep. 6, 2018 (DE) 102018215164.4

(51) Int. Cl. B60H 1/00; F25D 21/14

(52) U.S. Cl. CPC B60H 1/00328; B60H 1/00564; F25D 21/14

(57) ABSTRACT

An air-conditioning system for a motor vehicle includes an evaporator, a heating device arranged downstream of the evaporator, an evaporator bypass duct arranged below the evaporator, and at least one air guiding duct. The at least one air guiding duct has an inlet end that is communicatingly connected to the evaporator bypass duct and an outlet side that opens or ends between the evaporator and the heating device. The at least one air guiding duct is structured and arranged such that outside air flowing through the evaporator bypass duct and the air guiding duct(s) enters the heating device. The at least one air guiding duct includes a lateral collar extending outwardly therefrom, structured and arranged to facilitate discharging condensate from the evaporator into a condensate pan.

### CROSS-REFERENCE TO RELATED APPLICATION

This application claims priority to German Application DE 10 2018 215 164.4 filed on Sep. 6, 2018, the contents of which are hereby incorporated by reference in its entirety.

### TECHNICAL FIELD

The present invention relates to an air-conditioning system for a motor vehicle. The invention additionally relates to a motor vehicle having such an air-conditioning system.

### BACKGROUND

In particular in electric vehicles it is a primary objective to increase the efficiency of air-conditioning systems and thereby reduce an energy consumption for cooling or heating. In order to achieve this it is known to conduct unconditioned outside air past an evaporator. This is achieved in particular by way of a so-called evaporator bypass duct, which in modern evaporators runs above or laterally of the evaporator, since below the evaporator no arrangement is possible since in this region a condensate pan has to be arranged in order to be able to collect and discharge condensate precipitated on the evaporator.

However, it is disadvantageous here that the moist and warmer outside air above the evaporator in the evaporator bypass duct preferentially reaches a defroster a defroster duct, as a result of which there is a risk of vehicle windows misting up. disadvantageous is that through the warm, uncooled outside air which is additionally conducted past the evaporator above the same, no natural layering in the air-system can be achieved since the outside air does not cross or mix with the air flowing through the evaporator or the heating device. Because of this, regulating the also comparatively difficult. When the evaporator bypass duct is arranged laterally of evaporator, the even air quantity distribution over both sides and over the height of the evaporator can only be designed with comparatively major effort.

### SUMMARY

The present invention therefore deals with the problem of stating an air-conditioning system which overcomes the disadvantages known from the prior art. According to the invention, this problem is solved through the subject of the independent claim(s). Advantageous embodiments are subject of the dependent claims.

With an air-conditioning system for a motor vehicle, the present invention is the general idea of arranging an evaporator bypass duct below the evaporator or unconditioned outside air through the evaporator bypass duct below the evaporator outlet height of the evaporator, introduce the evaporator bypass duct into an air guiding or divide the same over individual air guiding ducts and feed air flowing through the air guiding ducts to a heating device, wherein the air guiding ducts in turn have lateral that the condensate that is incurred on the outlet side in the interior of the evaporator discharged between the individual air guiding ducts or via the collars downwards into a condensate pan. The air-conditioning system according to the invention comprises the previously described evaporator and a heating device that is arranged downstream of evaporator and the evaporator bypass duct running below the evaporator. Likewise is at least one air guiding duct which on the inlet side is communicatingly connected to evaporator bypass duct and on the outlet side ends between the evaporator and the device and at the same time is orientated in such a manner that outside air flowing the at least one air guiding duct enters the heating device. This at least one air guiding has collars extending laterally and outside of the same, which collars at their upper end connected to the evaporator, in particular to an outflow side of the evaporator and at lower end project into a condensate pan and thereby make possible discharging from the evaporator into the condensate pan. With the air-conditioning system the invention it is thus possible to conduct the comparatively warm outside air, since it cooled and not dehumidified, below the evaporator via the evaporator bypass duct and subsequently mix the said outside air via the at least one air guiding duct with the air passing through the evaporator, as a result of which a natural layering of the air flowing through the air-conditioning system can be achieved. Through the evaporator bypass arranged below the evaporator, it can be prevented in particular that the uncooled air therein directly exits upwards via a defroster duct to a windscreen where it causes Since the at least one air guiding duct with its outlet is located maximally at a quarter of height of the evaporator, the uncooled outside air can, even with the heating device not activated, be comparatively easily fed to a foot outlet or a foot well duct so that the air there is warmer and ensures a natural intermixing in the vehicle interior. The bypass air (outside air) flowing through the evaporator bypass duct and the as least one guiding duct, which is not dehumidified and warmer than air flowing through the is thus not admixed to a cold air path as a result of which misting-up can also be The bypass air (outside air) is rather fed to the heating device. Because of the collars, condensate incurred in the evaporator is not dragged along by the bypass air stream as of which a vapour formation on the heating device can be avoided. With the air-system according to the invention, dehumidified and cooled outside air thus enters a interior rather at the top, for example via a defroster duct, while the uncooled and more humid outside air enters the vehicle interior at the bottom. In the vehicle interior, the air sinks from the top down and the warmer air simultaneously rises from the bottom result of which the described intermixing materialises.

In an advantageous further development of the solution according to the invention, three air guiding ducts are provided next to one another with collars arranged in between. By way of this, both a reliable flow of the uncooled outside air (evaporator bypass air) and also a reliable discharge of the condensate can be created over the entire width of the evaporator.

Practically, the at least one air guiding duct and the associated collars are formed in one piece, in particular as a one-piece plastic injection moulding. In this case it is possible to produce the air guiding duct and the associated collars cost-effectively and in a high quality at the same time.

In an advantageous further development of the solution according to the so-called cold air path runs below the heating device. By way of this cold air path, which regulatable for example via a first flap, in particular a cold air flap, a volumetric flow passing through the heating device can be controlled. When no heating of the air flow is desired, the cold air flap can be opened and at least a part of the air flow flowing in the air-conditioning system be conducted past the heating device into a mixing chamber arranged behind the same.

In a further advantageous embodiment of the solution according to the invention, a second flap, in particular a bypass duct flap, for controlling an air mass flow in the evaporator bypass duct is provided. By way of the second flap, the air flow proportion flowing through the evaporator is thus comparatively easily regulatable.

In a further advantageous embodiment of the solution according to the invention, a duct portion is arranged on the condensate pan which forms a flow passage between the evaporator and the heating device, so that in the most favourable case the condensate pan and the duct portion can be formed as a one-piece plastic injection moulding.

Practically, the collars of the at least one air guiding duct form a flow guiding element for air exiting the evaporator. By way of these collars, guiding of the air exiting from the evaporator at the bottom in the direction of the cold air path is comparatively easily possible. Obviously, additional air guiding elements can also be arranged on the collar which make possible a further desirable deflection of the air flow.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

The drawings shows, in each case schematically,

FIG. 1 shows a sectional representation through an air-conditioning system according to the invention,

FIG. 2 shows a view of an evaporator bypass duct with altogether three air guiding ducts.

### DETAILED DESCRIPTION

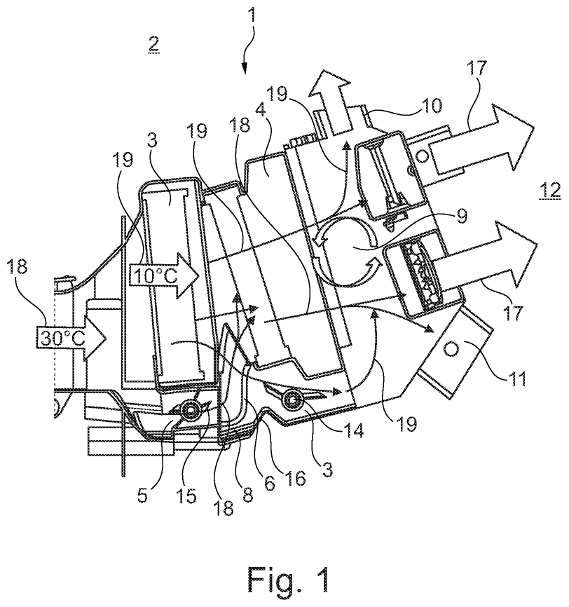

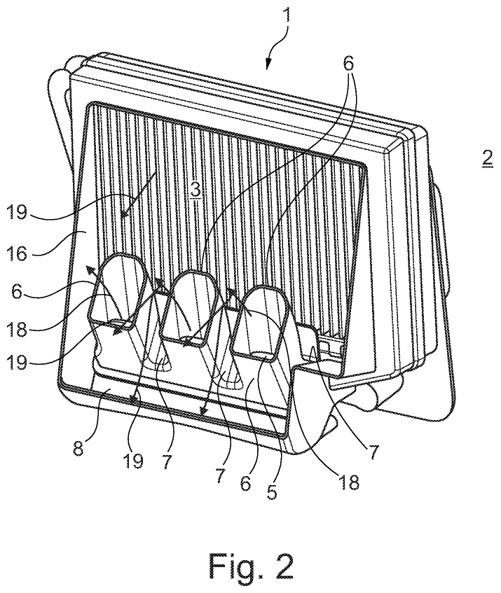

According to FIG. 1, an air-conditioning system 1 according to the invention for a motor vehicle 2 which is not otherwise shown comprises an evaporator 3 and a heating device 4 arranged downstream of the evaporator 3. Likewise provided is an evaporator bypass duct 5 which runs or is arranged below the evaporator 3. On the end side of the evaporator bypass duct 5 at least one air guiding duct 6, according to FIG. 2, altogether three air guiding ducts 6 are arranged there, wherein the air guiding duct 6 or the air guiding ducts 6 is/are communicatingly connected with the evaporator bypass duct 5 and ends/end on the outlet side between the evaporator 3 and the heating device 4 and is/are equipped in such a manner that outside air 18 flowing through the evaporator bypass duct 5 and the air guiding duct 6 enters the heating device 4. The air guiding duct 6 or the air guiding ducts 6 additionally have collars 7 running laterally and outside of the same, which at its/their upper end/ends are connected with an outflow side of the evaporator 3 and at its/their lower end/ends project into a condensate pan 8 and thereby make possible discharging condensate from the evaporator 3 into the condensate pan 8. With the air-conditioning system 1 according to the invention it is thus possible to keep the evaporator bypass air (outside air 18) flowing through the evaporator bypass duct 5 and the at least one air guiding duct 6, which is not dehumidified and warmer than air 19 that flowed through the evaporator 3, away from a cold air path 13, as a result of which misting-up can be prevented. The bypass air (outside air 18) is fed to the heating device 4 where it is heated and dried. The condensate incurred in the evaporator 3 is not dragged along by the bypass air flow because of the collars 7, as a result of which vapour forming on the heating device 4 can be avoided.

According to FIG. 2, three air guiding ducts 6 are arranged in the width direction next to one another, with collars 7 arranged in between. The at least one air guiding duct 6 and the associated collars 7 are preferentially formed in one piece, in particular as one-piece plastic injection moulding, and can thereby be produced not only cost-effectively but also in a high quality at the same time.

By way of the arrangement of the evaporator bypass duct 5 below the evaporator 3 according to the invention it is possible to conduct unconditioned, i.e. moist and warm outside air 18, past below the evaporator 3, and feed the same to a mixing chamber 9 arranged downstream of the heating device 4 only after the evaporator 3 or the heating device 4 also in a lower region. By way of this it can be prevented in particular, that the unconditioned, moist and warm outside air 18, as would be the case with an evaporator bypass duct 5 arranged above the evaporator 3, directly reaches a windscreen via a defroster duct 10 where it can undesirably result in the windscreen misting up. By conducting the unconditioned outside air 18 past at the bottom according to the invention, a “natural” layering can be additionally achieved in the case of which a foot well duct 11 can be supplied with warmer air 18 and a defroster duct 10 with colder air 19, so that the warmer air 18 exits in a vehicle interior 12 in the foot well while the colder air 19 exits through the defroster duct 10 in the upper region. By way of this, a significantly better, automatic intermixing and thus a more pleasant and more uniform air conditioning of the vehicle interior 12 can be achieved since the colder air 19 exiting at the top sinks downwards while the warmer air 18 exiting through the foot well duct 11 at the bottom, rises up.

Viewing FIG. 1 further it is evident that below the heating device 4 a cold air path 13 extends, which likewise contributes to a better intermixing of the air in the mixing chamber 9.

The unconditioned outside air 18, which is conducted through the evaporator bypass duct 5 below the evaporator 3, crosses the colder air flow 19 conducted through the evaporator 3 through the air outlet openings of the air guiding ducts 6 directed upwards where it ensures good intermixing. In addition the (cold) air flow 19 passing through the evaporator 3 can be conducted, after its exit from the evaporator 3, via the collars 7 downwards via the cold air path 13 and from there again up into the mixing chamber 9, where it is intermixed with the unconditioned outside air 18 that has exited from the air guiding duct 6 and passed through the heating device 4. An intermixing of the air flow 18 flowing through the evaporator bypass duct 5 thus takes place on the one hand by crossing the (evaporator) air flow 19 in a region between the evaporator 3 and the heating device 4 and once more in the mixing chamber 9.

The cooled air flow 19 exiting from the evaporator 3 in the lower region can be conducted via the collars 7 (see FIG. 2) to the cold air path 13, as a result of which the collars 7 in this case serve as flow guiding element for air 19 exiting from the evaporator 3 in particular in the lower region.

In the cold air path 13, a first controllable air flap 14 is arranged for controlling an air mass flow while in the evaporator bypass duct 5 for controlling an air mass flow 18 flowing there a second controllable air flap 15 is provided. By controlling the two air flaps 14, 15, a fine regulation of the air flow leading through the air-conditioning system 1 can be achieved.

Here, multiple ducts originate from the mixing chamber 9, namely the defroster duct 10 at the top described above, at least one ventilation duct 17 and at least one foot well duct 11 (bottom). The ventilation ducts 17 can be controlled or regulated via suitable flaps.

Looking at the FIG. 2 further it is evident that on the condensate pan 8 a duct portion 16 is arranged, which forms at least one part of a flow duct between the evaporator 3 and the heating device 4.

With the air-conditioning system 1 according to the invention it is possible to arrange an evaporator bypass duct 5 below the evaporator 3 and thereby achieve a particularly good intermixing of the unconditioned that is moist and warm outside air 18 with the air 19 cooled and dehumidified by the evaporator 3 and thereby establish in particular a natural layering in the vehicle interior 12. At the same time it is possible with the air-conditioning system 1 according to the invention despite the evaporator bypass duct 5 arranged below the evaporator 3 to collect the condensate separated in the evaporator 3 in a condensate pan 8 arranged below the evaporator 3. By way of the possibility of crossing the air flow 18 with the air flow 19 it is additionally possible to arrange the cold air path 13 in the lower region of the air-conditioning system 1 and in particular below the heating device 4.

A further major advantage is that the air-conditioning system 1 according to the invention is significantly more compact in construction and because of this requires less installation space. Apart from this, the acoustic sound penetration is reduced through the deflection of the air flow 18 flowing through the evaporator bypass duct 5 and thereby a noise-optimised operation made possible. Depending on the orientation of the outlet openings of the air guiding ducts 6 it is additionally possible to direct and guide the air flow 18 bypassing the evaporator 3 into certain regions of the heating device 4 and thereby influence the natural layering.

1. An air-conditioning system for a motor vehicle, comprising:
an evaporator;
a heating device arranged downstream of the evaporator;
an evaporator bypass duct arranged below the evaporator;
at least one air guiding duct having an inlet side that is communicatingly connected to the evaporator bypass duct and an outlet side that opens between the evaporator and the heating device, wherein the at least one air guiding duct is structured and arranged such that outside air flowing through the evaporator bypass duct and the at least one air guiding duct enters the heating device; and
wherein the at least one air guiding duct includes a plurality of lateral collars extending outwardly therefrom, wherein the plurality of lateral collars at a respective upper end are connected to an outflow side of the evaporator and at a respective lower end project into a condensate pan to facilitate discharging condensate from the evaporator into the condensate pan.

2. The air-conditioning system according to claim 1, wherein the at least one air guiding duct includes at least three air guiding ducts provided next to one another with the plurality of lateral collars arranged in between the at least three air guiding ducts.

3. The air-conditioning system according to claim 1, wherein the at least one air guiding duct and the the plurality of lateral collars are structured in one piece.

4. The air-conditioning system according to claim 1, further comprising a mixing chamber disposed downstream of the heating device, wherein the mixing chamber includes at least one defroster duct, at least one ventilation duct and at least one foot well duct extending downstream therefrom.

5. The air-conditioning system according to claim 1, further comprising a cold air path structured and arranged to run below the heating device.

6. The air-conditioning system according to claim 5, further comprising a controllable air flap provided in the cold air path for controlling an air mass flow therethrough.

7. The air-conditioning system according to claim 1, further comprising a controllable air flap provided in the evaporator bypass duct for controlling an air mass flow therethrough.

8. The air-conditioning system according to claim 1, wherein at least some of the plurality of lateral collars are structured and arranged to provide a flow guiding path for air exiting from the evaporator.

9. The air-conditioning system according to claim 1, further comprising a duct portion disposed on the condensate pan, structured and arranged to provide at least part of a flow duct between the evaporator and the heating device.

10. A motor vehicle, comprising an air-conditioning system, the air-conditioning system including:
an evaporator;
a heating device arranged downstream of the evaporator;
an evaporator bypass duct arranged below the evaporator;
at least one air guiding duct having an inlet side that is communicatingly connected to the evaporator bypass duct and an outlet side that opens between the evaporator and the heating device, wherein the at least one air guiding duct is structured and arranged such that outside air flowing through the evaporator bypass duct and the at least one air guiding duct enters the heating device;
a condensate pan arranged below the evaporator; and
wherein the at least one air guiding duct includes at least one lateral collar extending outwardly from the at least one air guiding duct, wherein the at least one lateral collar have an upper end connected to an outflow side of the evaporator and a lower end projecting into the condensate pan to facilitate discharging condensate from the evaporator into the condensate pan.

11. The motor vehicle according to claim 10, wherein the at least one air guiding duct includes at least two air guiding ducts arranged parallel to one another, and wherein the at least one lateral collar is structured and arranged to extend between the at least two air guiding ducts.

12. The motor vehicle according to claim 11, wherein the at least two air guiding ducts together with the at least one lateral collar define a flow guiding path for air exiting from the evaporator.

13. The motor vehicle according to claim 10, wherein the at least one air guiding duct and the at least one lateral collar are structured as a one-piece plastic injection-moulding part.

14. The motor vehicle according to claim 10, wherein the air-conditioning system further includes a mixing chamber disposed downstream of the heating device, wherein the mixing chamber includes at least one defroster duct, at least one ventilation duct and at least one foot well duct extending downstream therefrom.

15. The motor vehicle according to claim 10, wherein the air-conditioning system further includes a cold air path structured and arranged to run below the heating device.

16. The motor vehicle according to claim 15, wherein the cold air path includes a controllable air flap for controlling an air mass flow therethrough.

17. The motor vehicle according to claim 10, wherein the air-conditioning system further includes a controllable air flap provided in the evaporator bypass duct for controlling an air mass flow therethrough.

18. The motor vehicle according to claim 10, wherein the condensate pan includes a duct portion, structured and arranged to provide at least part of a flow duct between the evaporator and the heating device.

19. The air-conditioning system according to claim 6, further comprising a second controllable flap provided in the evaporator bypass duct for controlling an air mass flow therethrough.

20. An air-conditioning system for a motor vehicle, comprising:
an evaporator;
a heating device arranged downstream of the evaporator;
an evaporator bypass duct arranged below the evaporator;
a plurality of air guiding ducts respectively having an inlet side communicatingly connected to the evaporator bypass duct and an outlet side that ends between the evaporator and the heating device, wherein the plurality of air guiding duct are structured and arranged such that outside air flowing through the evaporator bypass duct and through the plurality of air guiding ducts enters the heating device;
a condensate pan arranged below the evaporator;
a plurality of collars extending laterally and outwardly from the plurality of air guiding ducts, wherein the plurality of collars each have a respective upper end connected to an outflow side of the evaporator and a respective lower end projecting into the condensate pan to facilitate discharging condensate from the evaporator into the condensate pan; and
wherein the plurality of air guiding ducts are arranged laterally next to one another and the plurality of collars are arranged in between the plurality of air guiding ducts.
